(19) United States
(12) Patent Application Publication
(10) Pub. No.: US 2013/0117420 A1
(43) Pub. Date: May 9, 2013

(54) APPARATUS AND METHOD FOR SETTING DATA TRANSMISSION PATH

(71) Applicants: Seung-Jae HAN, Seoul (KR); Soo-Hoon MOON, Seoul (KR)

(72) Inventors: Seung-Jae HAN, Seoul (KR); Soo-Hoon MOON, Seoul (KR)

(73) Assignee: Industry-Academic Cooperation Foundation, Yonsei University, Seoul (KR)

(21) Appl. No.: 13/303,051

(22) Filed: Nov. 22, 2011

(30) Foreign Application Priority Data
Nov. 4, 2011 (KR) 10-2011-0114518

(51) Int. Cl. G06F 15/177

(52) U.S. Cl. 709/220

(57) ABSTRACT

Disclosed are an apparatus and method for setting data transmission paths. The disclosed apparatus for setting data transmission paths may include: a cluster grouping unit configured to classify a plurality of clusters into two or more cluster groups each containing one or more clusters based on a distance from a sink node; a first data transmission path setting unit configured to set a first data transmission path at the cluster group level; and a second data transmission path setting unit configured to set a second data transmission path at the cluster level on a basis of the first data transmission path.

### CROSS-REFERENCE TO RELATED APPLICATIONS

This application claims under 35 U.S.C. §119(a) the benefit of Korean Application No. 10-2011-0114528 filed Nov. 4, 2011, the entire contents of which are incorporated herein by reference.

1. Technical Field

The present invention relates to an apparatus and method for setting data transmission paths in a wireless network that is partitioned into clusters.

2. Background Art

Sensor nodes are powered by limited energy resources (e.g. batteries), and as replacing these can be very difficult, an important issue in the field of wireless sensor networks is to maximize the lifespan of the sensor nodes.

In general, a sensor node generates data periodically or when a particular event occurs, and transfers the data to a sink node. This transmission of data is a major cause of energy consumption in a sensor node. Thus, in order to increase the lifespan of a sensor node, the data transmission path may need to be optimized.

A wireless network 100 according to the related art can be partitioned into two or more clusters 120, which each include a cluster head node 110 and one or more cluster member nodes, as illustrated in FIG. 1.

The cluster head node 110 may collect data generated by the cluster member nodes included in the cluster to which it belongs, and transfer the data to another cluster head node 120 or a sink node. In this case also, it may be necessary to set an optimal data transmission path in order to maximize the overall lifespan of the wireless network as described above.

However, greater sizes of the wireless network result in greater numbers of clusters included in the wireless network, in which case setting the data transmission path individually for all of the cluster head nodes can require increased computation time and an increased amount of computation.

### DISCLOSURE

### Technical Problem

In order to resolve the problems above, an aspect of the present invention is to propose an apparatus and method for setting data transmission paths with which the computation time and the amount of computation required for setting the data transmission paths can be reduced.

Other objectives of the present invention can be derived by the skilled person from the embodiments below.

### Technical Solution

To achieve the objective above, an embodiment of the present invention provides an apparatus for setting data transmission paths that includes: a cluster grouping unit configured to classify a plurality of clusters into two or more cluster groups each containing one or more clusters based on a distance from a sink node; a first data transmission path setting unit configured to set a first data transmission path at the cluster group level; and a second data transmission path setting unit configured to set a second data transmission path at the cluster level on a basis of the first data transmission path.

Another embodiment of the present invention provides a method for setting data transmission paths that includes: classifying a plurality of clusters into two or more cluster groups each containing one or more clusters based on a distance from a sink node; setting a first data transmission path at the cluster group level; and setting a second data transmission path at the cluster level on a basis of the first data transmission path.

### Advantageous Effects

An aspect of the present invention makes it possible to reduce the computation time and the amount of computation required for setting data transmission paths.

### DESCRIPTION OF DRAWINGS

FIG. 1 illustrates the structure of a wireless network partitioned into clusters according to the related art.

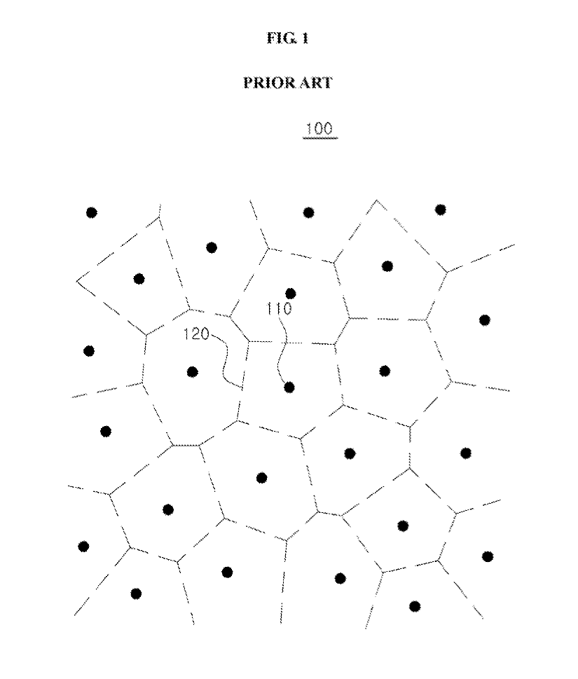

FIG. 2 is a block diagram illustrating the general composition of an apparatus for setting data transmission paths according to an embodiment of the present invention.

FIG. 3 illustrates an example of a wireless network to which an apparatus for setting data transmission paths according to an embodiment of the present invention can be applied.

FIG. 4 illustrates a Markov chain state diagram for the example of a wireless network shown in FIG. 3.

FIG. 5 is a conceptual illustration of the Markov decision process for an AFC algorithm.

FIG. 6 is a flowchart illustrating the overall flow of a method for setting data transmission paths according to an embodiment of the present invention.

### MODE FOR INVENTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In describing the drawings, like reference numerals refer to like components.

Certain embodiment of the invention will be described below in more detail with reference to the accompanying drawings.

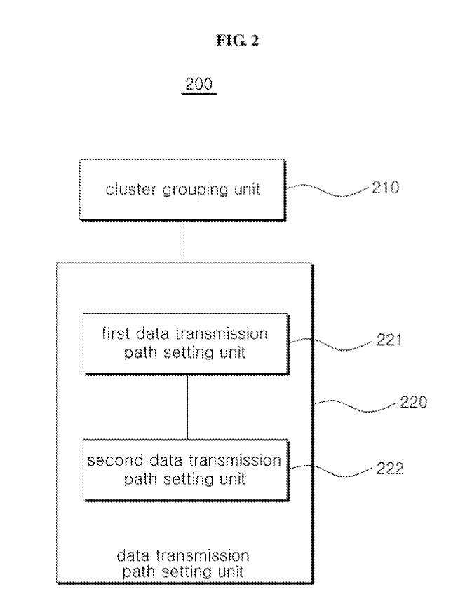

FIG. 2 is a block diagram illustrating the general composition of an apparatus for setting data transmission paths according to an embodiment of the present invention.

Referring to FIG. 2, an apparatus 200 for setting data transmission paths according to an embodiment of the invention may include a cluster grouping unit 210 and a data transmission path setting unit 220. Each component will be described below in further detail.

The cluster grouping unit 210 may classify (group) multiple clusters that exist in the field of a wireless network into two or more cluster groups. Here, each of the two or more cluster groups can contain one or more clusters.

According to an embodiment of the invention, the cluster grouping unit 210 can classify one or more clusters that have the same distance from the sink node, within a particular distance range, as one cluster group.

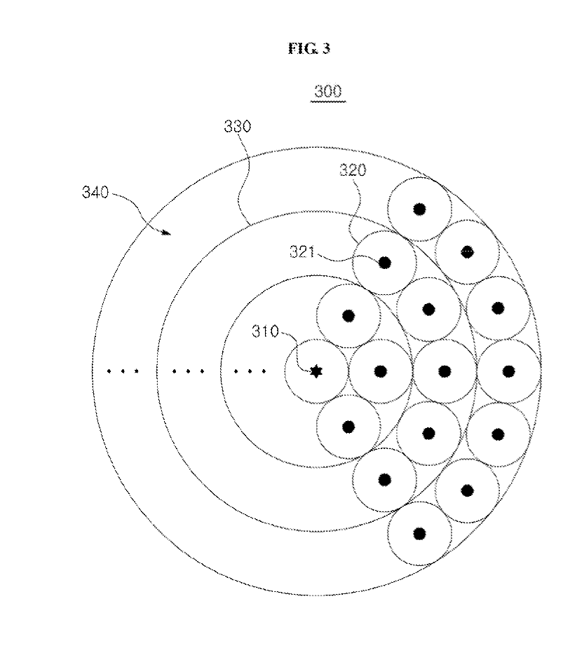

For instance, if the wireless network has a disc-like shape, the sink node 310 is located at the center of the disc-shaped wireless network, and multiple clusters 320 including the cluster head nodes 321 each have a circular shape, as illustrated in FIG. 3, then the cluster grouping unit 210 can partition the disc-shaped wireless network into multiple concentric circles 330 and can classify the one or more clusters 320 that are included in a zone 340 defined by two adjacent concentric circles as one cluster group. Thus, each zone 340 defined by two adjacent concentric circles can correspond to a cluster group.

Here, a zone 340 defined by two adjacent concentric circles can be shaped as a donut. For convenience, a donut-shaped zone 340 defined by two adjacent concentric circles will be hereinafter referred to as a “cluster-ring”.

According to an embodiment of the invention, the data generated by all nodes (including the cluster head node and cluster member nodes) within the wireless network can be transmitted by to the sink node by data communication between cluster head nodes, where the distance between the sink node and a cluster can be the distance between the sink node and the head node included in the cluster (the cluster head node). Here, the cluster head node can be pre-set and fixed from among the multiple nodes included in the cluster, or can be selected repetitively from among the multiple nodes based on the amounts of remaining energy of the multiple nodes.

Next, the data transmission path setting unit 220 may include a first data transmission path setting unit 221 and a second data transmission path setting unit 222, and may set the data transmission paths for transmitting data to the sink node (i.e. to the cluster or cluster group containing the sink node).

Here, the greatest data transmission range for each cluster head node can be greater than or equal to the radius of the wireless network. Thus, each cluster head node can transmit data to another cluster head node or two or more other cluster head nodes (i.e. the cluster head node can transmit data over a multi-path) that are located closer to the sink node (i.e. located within an inner cluster-ring).

To be more specific, the first data transmission path setting unit 221 may first set a first data transmission path, which is a transmission path at the level of cluster groups. In other words, the first data transmission path setting unit 221 may set a data transmission path (the first data transmission path), assuming each cluster group as an entity performing data transmission (i.e. a node).

According to an embodiment of the invention, the first data transmission path can be a multi-path. In other words, when determining the data transmission paths at the cluster group level, one cluster group can transmit data to another cluster group or two or more other cluster groups.

According to an embodiment of the invention, the first data transmission path setting unit 221 can set the first data transmission path for the i-th cluster group, from among the two or more cluster groups, by setting rates of transmittable data amounts for all possible transmission paths of the i-th cluster group.

For instance, in the example of FIG. 3, the multiple clusters 320 can be classified into five cluster groups (one cluster group containing the sink node and four cluster groups corresponding to the four cluster-rings), and the first data transmission path setting unit 221 can set the first data transmission paths between cluster groups with each of the five cluster groups as data-transmitting entities.

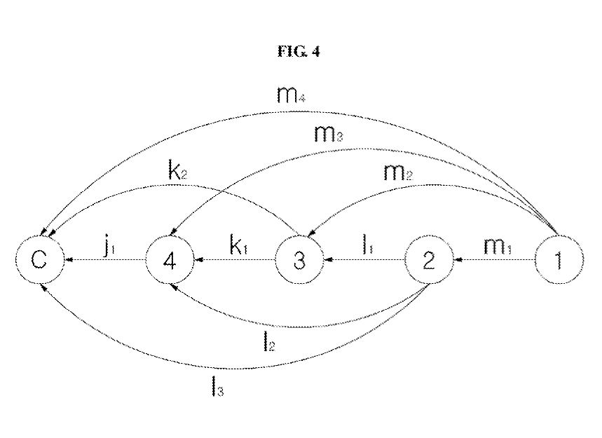

Here, all of the possible transmission paths for the five cluster groups can be expressed by the Markov chain state diagram illustrated in FIG. 4. Here, “c” represents the sink node (i.e. the cluster or cluster group containing the sink node), and “1”, “2”, “3”, and “4” represent the indexes of the cluster-rings, while the arrows between the cluster-rings represent data transmission paths between cluster-rings.

Here, the numbers of possible transmission paths for cluster-ring #1, cluster-ring #2, cluster-ring #3, and cluster-ring #4 are one, two, three, and four, respectively, and the first data transmission path setting unit 221 can set the first data transmission paths for the four cluster-rings by setting the rates of data (j₁, k₁, k₂, l₁, l₂, l₃, m₁, m₂, m₃, m₄) to be transmitted over each data transmission path for the four cluster-rings (here, j₁ has a value of 1, while k₁, k₂, l₁, l₂, l₃, m₁, m₂, m₃, m₄ all have values between 0 and 1, where k₁+k₂=1, l₁+l₂+l₃=1, m₁+m₂+m₃+m₄=1).

Next, the second data transmission path setting unit 222 may set a data transmission path (a second data transmission path), which is a transmission path at the level of clusters, on the basis of the first data transmission path. That is, the second data transmission path setting unit 222 may set the actual data transmission paths at the cluster level, based on the first data transmission path.

According to an embodiment of the invention, the second data transmission path setting unit 222 can set the second data transmission paths for the clusters included in the i-th cluster group of the two or more cluster groups, by deciding which cluster from among the one or more clusters included in another cluster group, i.e. the destination according to the first data transmission path for the i-th cluster group, the data is to be transmitted to, for each of the one or more clusters included in i-th cluster group.

For instance, if the first data transmission path at the cluster group level is set as in FIG. 4 above, with m₁=1, m₂=0, m₃=0, and m₄=0, then the second data transmission path setting unit 222 can set the second data transmission paths for one or more clusters included in cluster group #1 by deciding which cluster from among the one or more clusters included in cluster group #2 (the destination according to the first data transmission path) data is to be transmitted to, for each of the one or more clusters included in cluster group #1.

According to another embodiment of the invention, if the first data transmission paths and second data transmission paths are multi-paths, and the rates of transmission data amounts are set for each of the multi-paths, then the second data transmission path setting unit 222 can set the second data transmission paths for the one or more clusters included in the i-th cluster group by deciding what amount of data is to be transmitted to which cluster of the one or more clusters included in another cluster group, i.e. the destination according to the first data transmission path for the i-th cluster group, for each of the one or more clusters included in i-th cluster group, on the basis of the rates of transmittable data amounts for all possible transmission paths for the i-th cluster group.

For instance, if the first data transmission paths at the cluster group level are set as in the example of FIG. 4 above, with m₁=0.5, m₂=0.5, m₃=0, and m₄=0, then a cluster included in cluster group #1 must transmit data to a cluster included in cluster group #2 or a cluster included in cluster group #3, and in this case the second data transmission path setting unit 222 can set the second data transmission paths for one or more clusters included in cluster group #1 by deciding what amount (rate) of data is to be transmitted to which cluster of the one or more clusters included in cluster group 2 or cluster group 3 (which is the destination according to the first data transmission path), for each of the one or more clusters included in cluster group #1.

By first setting the first data transmission paths at the cluster group level, and afterwards setting the second data transmission paths at the cluster level, i.e. the actual data transmission paths, based on the first data transmission path in this manner, the time and amount of computation required for setting data transmission paths between all of the clusters included in the wireless network can be reduced.

In other words, a greater size of the wireless network entails an increased number of clusters included in the wireless network, which in turn increases the computation time and computation amount required for setting the paths, if the data transmission paths are set individually for all of the clusters.

In contrast, if the data transmission paths of the cluster group level (the first data transmission paths) are set first as in an embodiment of the present invention, generalized data transmission paths can be set between clusters with less computation time and smaller amount of computation, after which the actual data transmission paths of the cluster level (the second data transmission paths) can be set based on the generally set data transmission paths (the first data transmission paths) to also reduce the computation time and amount of computation required for the actual data transmission paths (the second data transmission paths). Thus, the overall computation time and amount of computation required for setting data transmission paths between clusters can be reduced for all of the clusters.

In order to set the first data transmission paths and second data transmission paths, an apparatus 200 for setting data transmission paths may require information on all clusters or all nodes present within the wireless network. Thus, it may be preferable to install the apparatus 200 for setting data transmission paths at the sink node, where the information on all clusters in the wireless network can be obtained.

A description will now be provided below on an example of the operation of a first data transmission path setting unit 221 that sets the rates of transmittable data amounts for every possible transmission path of two or more cluster groups, and on an example of the operation of a second data transmission path setting unit 222 that sets the second data transmission paths at the cluster level.

1. Setting the Rates of Transmittable Data Amounts for Every Possible Transmission Path

According to an embodiment of the invention, the first data transmission path setting unit 221 can set the rates of transmittable data amounts for all possible transmission paths using an adaptive flow control (AFC) algorithm, in order to minimize the overall amount of energy consumption of the wireless network. This is described in more detail as follows.

According to the AFC algorithm, the determining of transmission data amounts over all possible data transmission paths between nodes (i.e. cluster groups) can be expressed by a state transition probability matrix P, and the elements of the state transition probability matrix P can be quantized with a particular level of granularity u.

A state s belongs to a state set S, and in each state, an action α is randomly selected from an action set A. Here, an action represents an increase or a decrease in the value of an element within the state transition probability matrix P.

After an action α is performed, the state moves from sₖ to sₖ₊₁, and the action α is evaluated by way of a computation of benefits in terms of energy efficiency. The evaluation results (i.e. “reward”) of the action α is reflected as feedback in an action preference matrix Q. In the next state, the operation of selecting an action α and the operation of reflecting the “reward” in the action preference matrix Q are performed again.

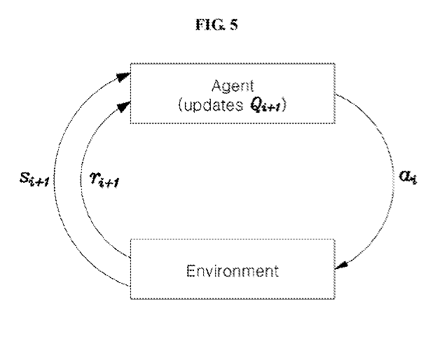

FIG. 5 conceptually illustrates the Markov decision process for an AFC algorithm such as that described above.

Referring to FIG. 5, the “Agent” may select an action, the “Environment” may feed back the “reward”, and the “Agent” may update the action preference matrix Q. Here, the preference values Q(s,α) for all possible state-action pairs (s,α) may be stored in the action preference matrix Q (the initial values for the preference values Q(s,α) may be set to 0).

The “Agent” may select an action αₖ based on values of the elements of the action preference matrix for the current state sₖ (k is an integer and represents time cycle). Here, the action a can be randomly selected in consideration of the value of Q(s,α), as expressed below in Equation 1.

Pr(αₖ=α|sₖ=s)=e^{Q(s,α)}/Σ_{b}e^{Q(s,b)} [Equation 1]

When the action αₖ and the next state sₖ₊₁ are decided, the “Environment” computes the “reward” of the action αₖ. Here, the “reward” represents the benefit in energy consumption derived from the action αₖ.

The “Environment” may compute the “reward” by using an energy consumption function E. To be more specific, the “Environment” can compute the “reward” based on Equation 2 below.

$$R ( {s}_{k} , {a}_{k} ) = \frac{E ( {s}_{k} ) - E ( {s}_{k + 1} )}{max ( E ( {s}_{k} ) , E ( {s}_{k + 1} ) )} \qquad [ Equation 2 ]$$

Here, R(sₖ, αₖ) is the “reward”, in which the difference between the amount of energy consumption E(sₖ) at state sₖ and the amount of energy consumption E(sₖ₊₁) at state sₖ₊₁ is normalized to the larger of E(sₖ) and E(sₖ₊₁). The amount of energy consumption E(s) can be expressed by Equation 3 and Equation 4 as follows.

$$\begin{matrix}E ( s ) = {max}_{u ∈ U} ( {\sum }_{u ∈ N ( v )}^{ } {f}_{u , v} \cdot {t}_{u , v} + {\sum }_{u ∈ N ( v )}^{ } {f}_{v , u} \cdot {r}_{u , v} ) & [ Equation 3 ] \\ E ( s ) = {\sum }_{v ∈ U}^{ } ( {\sum }_{u ∈ N ( v )}^{ } {f}_{u , v} \cdot {t}_{u , v} + {\sum }_{u ∈ N ( v )}^{ } {f}_{v , u} \cdot {r}_{u , v} ) . & [ Equation 4 ]\end{matrix}$$

Here, U represents the set of cluster groups excluding the cluster group containing the sink node, u and v represent indexes of cluster groups, N(v) represents the set of cluster groups neighboring the cluster group v, f_{u,v} represents the amount of data transferred from cluster group u to cluster group v, t_{u,v} represents the link weight for the transmitted traffic between cluster group u and cluster group v from the perspective of cluster group u, and r_{u,v} represents the link weight for the received traffic between cluster group u and cluster group v from the perspective of cluster group u.

Equation 3 is for calculating the maximum amount of energy consumption per unit zone in the cluster-ring shape, while the first formula in Equation 4 is for calculating the sum of energy consumption amounts.

The action preference matrix Q may be updated after performing an action. If the “reward” has a positive value, then the “Agent” may select an action having a high probability. The “reward” may be reinforced by the repeated action and feedback processes. The updating of the action preference matrix Q can be expressed by Equation 5 as follows.

Q(sₖ,αₖ)=Q(sₖ,αₖ)+γ·R(sₖ,αₖ) [Equation 5]

Here, γ represents a parameter for adjusting the speed of the feedback.

When the updating of the action preference matrix Q is finished, the selection of an action may be performed at the next state, to repeat the AFC algorithm.

The following Table 1 shows code for the AFC algorithm described above.

TABLE 1

| 1: | initialize S, P, Q; | | |
|---|---|---|---|
| 2: | ∀sεS, ∀aεA; | | |
| 3: | k = 0; | | |
| 4: | Loop | | |
| 5: | | Choose aₖ in sₖ according to Gibbs softmax method | |
| 6: | | | Pr(aₖ = a \| sₖ = s) = e^{Q(s,a)}/Σ_{b}e^{Q(s,b)}_{□} |
| 7: | | Get reward from action | |
| 8: | | | $R ( {s}_{k} , {a}_{k} ) = \frac{E ( {s}_{k} ) - E ( {s}_{k + 1} )}{max ( E ( {s}_{k} ) , E ( {s}_{k + 1} ) )} □$ |
| 9: | | Update Q | |
| 10: | | | Q(sₖ, aₖ) = Q(sₖ, aₖ) + γ · R(sₖ, aₖ) |
| 11: | | Move to the next state | |
| 12: | | | k=k+1 |

| | |
|---|---|
| 13: | end loop; |

2. Setting the Second Data Transmission Paths at the Cluster Level

After the setting of the first data transmission paths is complete, the second data transmission path setting unit 222 can set the second data transmission paths at the cluster level using an FA-C algorithm (flow augmentation algorithm for clustered networks).

A detailed description will be provided below on the operation of the second data transmission path setting unit 222 that sets the second data transmission paths, when the first data transmission paths have been set as in the example of FIG. 4.

The FA-C algorithm may be divided into two phases; one is the phase of selecting a cluster head node (i.e. a relay node, which serves as an entity that transmits data at the level of clusters) to set the data transmission path, and the other is the phase of transmitting data according to the set data transmission path.

First, in the phase of selecting a cluster head node to set the data transmission path, a cluster member node having the greatest amount of remaining energy from among the cluster member nodes included in each cluster may be selected as the cluster head node. Then, the next cluster head node may be selected, which will transmit data from the cluster head node included in the source cluster group (the starting point of the data transmission) in the direction of the sink node.

Here, the cluster head node that minimizes the link cost, as expressed by Equation 6 below, may be selected as the next cluster head node, from among the one or more cluster head nodes included in the next cluster group according to the first data transmission path.

costᵢⱼ=(pₜₓ(dᵢⱼ))^{x}^{_{I}}Eᵢ^{-x}^{₂}Eᵢ^{x}^{₃}+(pᵣₓ(dᵢⱼ))^{x}^{_{I}}Eⱼ^{-x}^{₂}Eⱼ^{x}^{₃} [Equation 6]

Here, costᵢⱼ the link cost of the link (i,j), xᵢ, x₂, and x₃ represent weighting factors having positive values, dᵢⱼ represents the distance of the link (i,j), and pₜₓ represents a function for the energy consumed during data transmission.

As a result of performing the AFC algorithm, a cluster head node can have multiple next cluster head nodes (the multiple next cluster head nodes are each contained in different cluster groups). Thus, in a cluster head node, the operation of selecting the next cluster head node can be performed repetitively.

Next, in the phase of transmitting data according to the set data transmission path, the cluster head node may collect data from the member nodes of its cluster, and may transmit the collected data to the next cluster head node. Here, the amount of data transmitted can be set based on the amount of data decided according to the AFC algorithm.

The following Table 2 shows code for the AFC algorithm described above.

TABLE 2

| 1: For each cluster-ring in network | |
|---|---|
| 2: | For each cluster in cluster-ring |

| | |
|---|---|
| 3: | Find a node which has the most residual energy |

| | |
|---|---|
| 4: | and make it a relay node; |

| | |
|---|---|
| 5: | If next hop is sink node |

| | |
|---|---|
| 6: | End for each cluster in cluster-ring; |

| | |
|---|---|
| 7: | For each next cluster-ring of non-zero data flow |

| | |
|---|---|
| 8: | Find a node which has the minimum link cost |

| | |
|---|---|
| 9: | in transmission range given by |

| 10: | |
|---|---|
| costᵢⱼ =(pₜₓ(dᵢⱼ))^{x}^{₁} Eᵢ^{-x}^{₂} Eᵢ^{x}^{₃} +(pᵣₓ(dᵢⱼ))^{x}^{₁} Eⱼ^{-x}^{₂} Eⱼ^{x}^{₃} | |
| 11: | If next hop is sink node |

| | |
|---|---|
| 12: | End for each cluster in cluster-ring; |

| | |
|---|---|
| 13: | Goto line 7; |

| | |
|---|---|
| 14: | End for each next cluster-ring of non-zero data flow; |

| | |
|---|---|
| 15: | End for each cluster in cluster-ring; |

16: End for each cluster-ring in network;

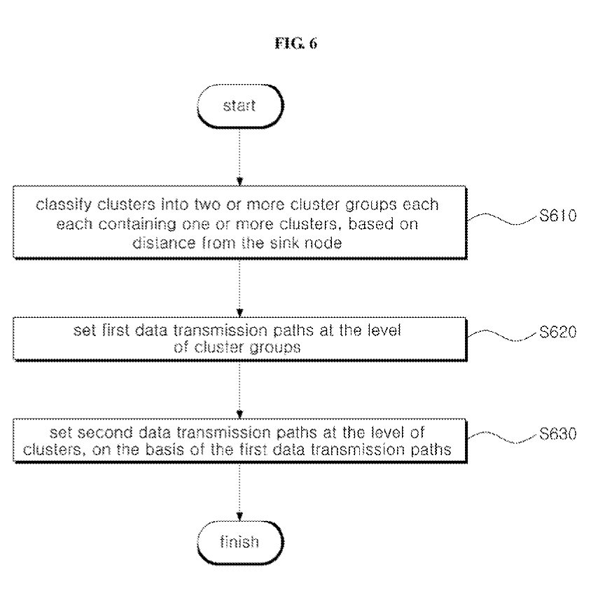

FIG. 6 is a flowchart illustrating the overall flow of a method for setting data transmission paths according to an embodiment of the present invention. A description will be provided below on the process performed for each step.

First, in step S610, a multiple number of clusters may be classified into two or more cluster groups, each containing one or more clusters, based on the distances from the sink node.

According to an embodiment of the invention, one or more clusters having the same distance from the sink node, within a particular distance range, can be classified as one cluster group in step S610.

Also, according to an embodiment of the invention, the distance between the sink node and a cluster can be the distance between the sink node and the cluster head node included in the cluster.

If the field of a wireless network that includes a sink node and a multiple number of clusters is shaped as a disc, the sink node is located at the center of the disc shape, and the multiple clusters have circular shapes, then step S610 can include partitioning the field of the wireless network into multiple concentric circles, and classifying one or more clusters, which are included in a zone defined by two adjacent concentric circles, as one cluster group.

Next, in step S620, the first data transmission paths at the level of cluster groups may be set.

According to an embodiment of the invention, if the first data transmission paths are multi-paths, then step S620 can include setting the first data transmission paths for the i-th cluster group, from among the two or more cluster groups, by setting the rates of transmittable data amounts for all possible transmission paths of the i-th cluster group.

Finally, in step S630, the second data transmission paths at the level of clusters may be set on the basis of the first data transmission paths.

According to an embodiment of the invention, step S630 can include setting the second data transmission paths for one or more clusters included in the i-th cluster group of the two or more cluster groups, by deciding which cluster from among the one or more clusters included in another cluster group, i.e. the destination according to the first data transmission path for the i-th cluster group, the data is to be transmitted to, for each of the one or more clusters included in i-th cluster group.

Also, according to an embodiment of the invention, if the first data transmission paths and second data transmission paths are multi-paths, then step S630 can include setting the second data transmission paths for the one or more clusters included in the i-th cluster group by deciding what amount of data is to be transmitted to which cluster of the one or more clusters included in another cluster group, i.e. the destination according to the first data transmission path for the i-th cluster group, for each of the one or more clusters included in i-th cluster group, on the basis of the rates of transmittable data amounts for all possible transmission paths for the i-th cluster group.

The descriptions above are directed at an embodiment of a method for setting data transmission paths according to the present invention, and the features of the apparatus 200 for setting data transmission paths described above with reference to FIG. 2 can also be applied to the present embodiment. As such, the description of the method for setting data transmission paths will not be provided in further detail.

The embodiments of the invention can be implemented in the form of a program of instructions executable by various computer means and can be recorded on a computer-readable medium. The computer-readable medium can include a program of instructions, data files, data structures, etc., or a combination thereof. The program of instructions recorded on the medium can be such that is especially designed for the present invention or is available to the skilled person in the computer software industry. Examples of a computer-readable recording medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc. Examples of the program of instructions may include not only machine language codes produced by a compiler but also high-level language codes that can be executed by a computer through the use of an interpreter, etc. The hardware mentioned above can be made to operate as one or more software modules that perform the actions of the embodiments of the invention, and vice versa.

While the invention has been described above using particular items, such as specific components, etc., and limited embodiments and drawings, these are merely provided to aid the overall understanding of the invention. The invention is not to be limited to the above embodiments, and those of ordinary skill in the art may conceive various modifications and alterations from the above disclosure. As such, the spirit of the invention is not to be defined only by the embodiments described above, and it is to be appreciated that not only the scope of claims set forth below but also their equivalents and substantially equivalent variations are encompassed within the spirit of the invention.

1. An apparatus for setting data transmission paths, the apparatus comprising:
a cluster grouping unit configured to classify a plurality of clusters into two or more cluster groups each containing one or more clusters based on a distance from a sink node;
a first data transmission path setting unit configured to set a first data transmission path at a level of the cluster groups; and
a second data transmission path setting unit configured to set a second data transmission path at a level of the clusters on a basis of the first data transmission path.

2. The apparatus for setting data transmission paths of claim 1, wherein the second data transmission path setting unit sets a second data transmission path for one or more clusters included in an i-th cluster group from among the two or more cluster groups, by deciding which cluster of the one or more clusters included in another cluster group, designated as a destination according to a first data transmission path for the i-th cluster group, data is to be transmitted to for each of the one or more clusters included in i-th cluster group.

3. The apparatus for setting data transmission paths of claim 1, wherein the first data transmission path is a multi-path, and
the first data transmission path setting unit sets a first data transmission path for an i-th cluster group from among the two or more cluster groups, by setting rates of transmittable data amounts for all possible transmission paths of the i-th cluster group.

4. The apparatus for setting data transmission paths of claim 3, wherein the second data transmission path is a multi-path, and
the second data transmission path setting unit sets a second data transmission path for one or more clusters included in the i-th cluster group, by deciding what amount of data is to be transmitted to which cluster of the one or more clusters included in another cluster group, designated as a destination according to a first data transmission path for the i-th cluster group, for each of the one or more clusters included in i-th cluster group, on a basis of the rates of transmittable data amounts for all possible transmission paths.

5. The apparatus for setting data transmission paths of claim 1, wherein the cluster grouping unit classifies one or more clusters having a same distance from the sink node within a particular distance range as one cluster group.

6. The apparatus for setting data transmission paths of claim 1, wherein a distance between the sink node and the cluster is a distance between the sink node and a cluster head node included in the cluster.

7. The apparatus for setting data transmission paths of claim 1, wherein a wireless network including the sink node and a plurality of clusters has a disc-like shape, the sink node is located at a center of the disc-like shape, the plurality of clusters have circular shapes,
and wherein the cluster grouping unit partitions the wireless network into a plurality of concentric circles and classifies one or more clusters included in a zone defined by two adjacent concentric circles as one cluster group.

8. A method for setting data transmission paths, the method comprising:
classifying a plurality of clusters into two or more cluster groups each containing one or more clusters based on a distance from a sink node;
setting a first data transmission path at a level of the cluster groups; and
setting a second data transmission path at a level of the clusters on a basis of the first data transmission path.

9. The method of claim 8, wherein the setting of the second data transmission path comprises:
setting a second data transmission path for one or more clusters included in an i-th cluster group from among the two or more cluster groups, by deciding which cluster of the one or more clusters included in another cluster group, designated as a destination according to a first data transmission path for the i-th cluster group, data is to be transmitted to for each of the one or more clusters included in i-th cluster group.

10. The method of claim 8, wherein the first data transmission path is a multi-path, and
the setting of the first data transmission path comprises:
setting a first data transmission path for an i-th cluster group from among the two or more cluster groups, by setting rates of transmittable data amounts for all possible transmission paths of the i-th cluster group.

11. The method of claim 10, wherein the second data transmission path is a multi-path, and
the setting of the second data transmission path comprises:
setting a second data transmission path for one or more clusters included in the i-th cluster group, by deciding what amount of data is to be transmitted to which cluster of the one or more clusters included in another cluster group, designated as a destination according to a first data transmission path for the i-th cluster group, for each of the one or more clusters included in i-th cluster group, on a basis of the rates of transmittable data amounts for all possible transmission paths.

12. The method of claim 8, wherein the classifying into two or more cluster groups comprises:
classifying one or more clusters having a same distance from the sink node within a particular distance range as one cluster group.

13. The method of claim 8, wherein a distance between the sink node and the cluster is a distance between the sink node and a cluster head node included in the cluster.

14. The method of claim 8, wherein a wireless network including the sink node and a plurality of clusters has a disc-like shape, the sink node is located at a center of the disc-like shape, the plurality of clusters have circular shapes,
and wherein the classifying into two or more cluster groups comprises partitioning the wireless network into a plurality of concentric circles and classifying one or more clusters included in a zone defined by two adjacent concentric circles as one cluster group.

15. A computer-readable recorded medium executable by a computer, tangibly embodying a program of instructions configured to perform the method of claim 8.
